(19) United States
(12) Patent Application Publication
(10) Pub. No.: US 2025/0314625 A1
(43) Pub. Date: Oct. 9, 2025

(54) Quantification Method, Analysis System, and Recording Medium

(71) Applicant: SHIMADZU CORPORATION, Kyoto-shi (JP)

(72) Inventor: Akira NODA, Kyoto-shi (JP)

(21) Appl. No.: 19/098,885

(22) Filed: Apr. 2, 2025

(30) Foreign Application Priority Data
Apr. 3, 2024 (JP) 2024-060113

(51) Int. Cl. G01N 30/86; G01N 30/06; G01N 30/32; G01N 30/72

(52) U.S. Cl. CPC G01N 30/8631; G01N 30/06; G01N 30/72; G01N 2030/065; G01N 2030/324

(57) ABSTRACT

Provided is a method for quantifying a specific component contained in a measurement sample. The method includes: obtaining a measurement spectrum at each of a plurality of points in time by analyzing the measurement sample with chromatography; deriving an index value at each point of the plurality of points in time, by applying a filter for extracting the specific component, to the measurement spectrum at the point of the plurality of points in time; obtaining a chromatogram by arranging one or more index values at respective one or ones of the plurality of points in time; and quantifying the specific component based on a peak of the chromatogram.

### CROSS REFERENCE TO RELATED APPLICATIONS

This nonprovisional application is based on Japanese Patent Application No. 2024-060113 filed on Apr. 3, 2024 with the Japan Patent Office, the entire contents of which are hereby incorporated by reference.

### BACKGROUND OF THE INVENTION

### Field of the Invention

The present disclosure relates to analysis of measurement outputs of a measuring instrument.

### Description of the Background Art

WO2020/225864 discloses that a measurement sample is analyzed with chromatography to obtain respective absorption spectra at a plurality of points in time, and respective total intensities of the absorption spectra at the points in time are arranged in the direction of time to obtain a chromatogram, thereby quantifying a component corresponding to a peak of the chromatogram.

### SUMMARY OF THE INVENTION

In order to accurately quantify a specific component in a mixture, it has conventionally been required to set a long separation time by supplying a mobile phase at low speed, for example, so that peaks of other components do not overlap.

The present disclosure is made in view of the above circumstances, and an object of the present disclosure is to provide a technique for quantifying a specific component in a mixture at high speed with high accuracy.

A quantification method according to an aspect of the present disclosure is a method for quantifying a specific component contained in a measurement sample, and the quantification method includes: obtaining a measurement spectrum at each of a plurality of points in time by analyzing the measurement sample with chromatography; deriving an index value at each point of the plurality of points in time, by applying a filter for extracting the specific component, to the measurement spectrum at the point of the plurality of points in time; obtaining a chromatogram by arranging one or more index values at respective one or ones of the plurality of points in time; and quantifying the specific component based on a peak of the chromatogram.

An analysis system according to an aspect of the present disclosure includes: a measuring instrument connected to a reaction device that generates a product through chemical change of one or more precursors, the measuring instrument measuring a measurement spectrum of a measurement sample extracted from the product generated at the reaction device; and an analyzer that analyzes an output of the measuring instrument, and the analyzer performs the above-described quantification method on the measurement sample extracted from the product.

A recording medium according to an aspect of the present disclosure stores a program in a non-transitory manner, and the program, when being executed by a computer, causes the computer to perform the above-described quantification method.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of a generation system according to an embodiment of the present disclosure.

FIG. 2 is a block diagram showing a configuration of a controller 100 in FIG. 1.

FIG. 3 is a diagram showing a chromatogram of a general mixture obtained with chromatography performed at a first flow rate.

FIG. 4 is a diagram showing a chromatogram of the mixture in FIG. 3 obtained with chromatography performed at a second flow rate.

FIG. 5 is a diagram showing the chromatogram in FIG. 3 together with a waveform processed by means of a filter.

FIG. 6 is a diagram showing the chromatogram in FIG. 4 together with a waveform processed by means of a filter.

FIG. 7 is a diagram showing a result of measurement obtained when the mixture mentioned in connection with in FIGS. 3 to 6 is introduced into a measuring instrument 340 without being passed through a separation column 330.

FIG. 8 is a diagram schematically showing an example of a result of measurement of a general sample.

FIG. 9 is a diagram showing an example of a reference spectrum.

FIG. 10 is a flowchart of a process performed by an analyzer 300 to provide information for monitoring a manufacturing process at a reaction device 200.

FIG. 11 is a flowchart of a subroutine of step S20.

FIG. 12 is a flowchart of a subroutine of step S40.

### DESCRIPTION OF THE PREFERRED EMBODIMENTS

Embodiments of the present disclosure are described in detail hereinafter with reference to the drawings. In the drawings, the same or corresponding parts are denoted by the same reference characters, and a description thereof is not herein repeated.

### Configuration of Generation System

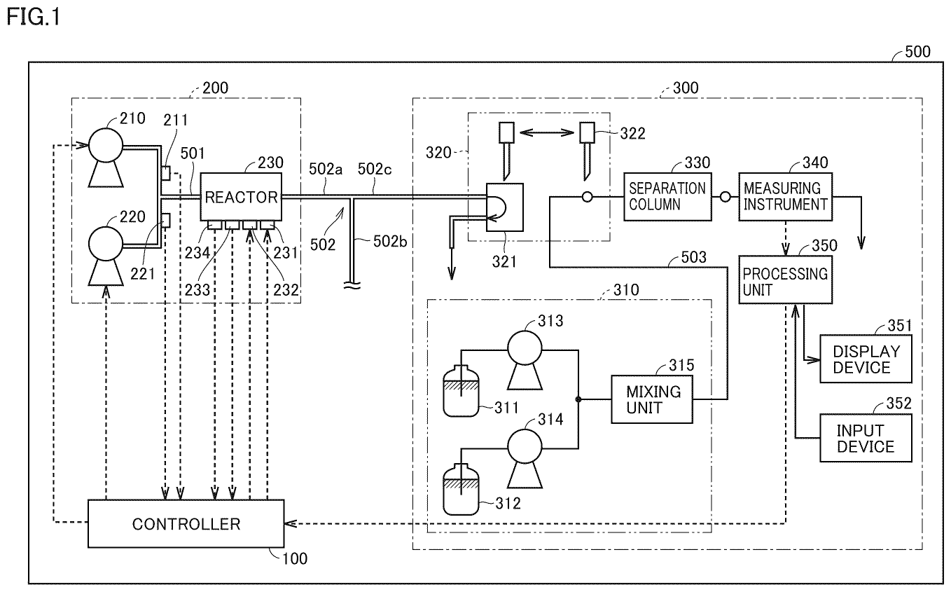

A generation system according to embodiments of the present disclosure is described in detail hereinafter with reference to the drawings. FIG. 1 is a diagram showing a configuration of a generation system according to an embodiment of the present disclosure. As shown in FIG. 1, generation system 500 includes a controller 100, a reaction device 200, and an analyzer 300. Analyzer 300 includes a separation column for liquid chromatography to separate a sample using an eluant.

Controller 100 is configured as a computer, for example, and includes a CPU (Central Processing Unit) and a memory. Controller 100 obtains various measurement results from reaction device 200, and obtains measurement results from analyzer 300, to control operation of reaction device 200 based on the obtained results. Details of controller 100 are described later herein.

Reaction device 200 has a function of manufacturing pharmaceutical products, food products, or chemical products, for example, by continuous manufacturing.

Analyzer 300 uses a filter described later herein to analyze a result of measurement of a target solution generated during continuous manufacturing at reaction device 200, and thereby provide information for monitoring a process of the manufacturing at reaction device 200.

Reaction device 200 includes liquid delivery units 210 and 220 and a reactor 230. A first liquid material and a second liquid material are supplied respectively to liquid delivery units 210 and 220 from factory equipment or the like. The first liquid material contains a first precursor for a product. The second liquid material contains a second precursor for the product. Liquid delivery units 210 and 220 are liquid delivery pumps, for example, and respectively deliver, by pressure, the first and second liquid materials to reactor 230 through a flow path 501. Flow path 501 is provided with flow rate sensors 211 and 221 that measure respective amounts of the delivered first and second liquids, respectively.

Reactor 230 includes a CSTR (continuous stirred-tank reactor) or a plug flow reactor, for example, and continuously generates a predetermined product (hereinafter referred to as reaction product) by causing the first liquid material and the second liquid material to react with each other. Reactor 230 is provided with a temperature adjustment device 231 that adjusts the internal temperature and a pressure adjustment valve 232 that adjusts the internal pressure. Reactor 230 is also provided with a temperature sensor 233 and a pressure sensor 234 that measure the internal temperature and the internal pressure, respectively.

An evaluation value indicating the quality, such as the yield or the purity, of a reaction product generated by reactor 230 varies depending on the residence time of the first liquid material, the residence time of the second liquid material, the reaction temperature, or the reaction pressure, in reactor 230. The residence time of the first liquid material in reactor 230 is determined by the amount of the delivered first liquid material and the flow path shape (volume) of reactor 230. Similarly, the residence time of the second liquid material in reactor 230 is determined by the amount of the delivered second liquid material and the flow path shape of reactor 230.

A flow path 502 including a main pipe 502a and branch pipes 502b and 502c is connected to a downstream portion of reactor 230. Most of the reaction product generated by reactor 230 is delivered downstream of a factory production line through branch pipe 502b which is branched from main pipe 502a, as a product or a partially-completed product. In contrast, a part of the reaction product generated by reactor 230 is guided, as a sample to be analyzed, to analyzer 300 through branch pipe 502c which is branched from main pipe 502a. A pump for guiding the reaction product from reactor 230 to flow path 502 may be provided.

In the present embodiment, the cross-sectional area of flow path 501 through which the first or second liquid material flows and the cross-sectional area of flow path 502 through which the reaction product flows are larger than the cross-sectional area of a flow path 503 through which the eluant flows in analyzer 300, as described later herein. In this case, in reaction device 200, a large amount of the reaction product can be generated, and the generated reaction product can be delivered downstream. Meanwhile, in analyzer 300, diffusion of the sample in flow path 503 can be suppressed, and the performance of separating the sample can be improved.

Analyzer 300 includes an eluant supply unit 310, a sample supply unit 320, a separation column 330, a measuring instrument 340, and a processing unit 350. Analyzer 300 may be placed in the same factory as the factory where reaction device 200 is placed, or may be placed in a research facility or the like different from the factory where reaction device 200 is placed. A display device 351 and an input device 352 are connected to processing unit 350. In the case where controller 100 has functions similar to functions of processing unit 350, analyzer 300 may not be provided with processing unit 350.

Eluant supply unit 310 includes bottles 311 and 312, liquid delivery units 313 and 314, and a mixing unit 315. Bottles 311 and 312 respectively store an aqueous solution and an organic solvent as eluants, for example. Liquid delivery units 313 and 314 are liquid delivery pumps, for example, and deliver, by pressure, respective eluants stored in bottles 311 and 312 through flow path 503, respectively. Mixing unit 315 is a gradient mixer, for example. Mixing unit 315 mixes, at an arbitrary ratio, the eluants delivered by pressure from liquid delivery units 313 and 314 respectively, and supplies the mixed eluants while changing the ratio.

Sample supply unit 320 is an autosampler, for example, and includes a flow vial 321 and a sampling needle 322. The sample generated by reaction device 200 is guided to flow vial 321 through flow path 502, and thereafter drained to a waste liquid unit (not shown). Sampling needle 322 sucks the sample in flow vial 321, and injects the sucked sample into separation column 330 together with the eluants supplied by eluant supply unit 310. Sampling needle 322 is an example of a sample extraction unit. The sample to be injected into separation column 330 may be diluted appropriately in sample supply unit 320.

Separation column 330 is housed inside a column thermostatic bath (not shown) and adjusted to a predetermined constant temperature. Separation column 330 separates each component from the sample injected by sample supply unit 320, based on difference in chemical property or composition. Measuring instrument 340 includes an absorptiometer or an RI (Refractive Index) measuring instrument, for example, and detects the component of the sample separated by separation column 330. In the case where measuring instrument 340 is an absorptiometer, measuring instrument 340 may be configured as one absorptiometer capable of measuring respective absorbances of a plurality of wavelengths, or may be configured as a plurality of absorptiometers capable of measuring respective absorbances of different wavelengths. The sample that has passed through measuring instrument 340 is drained. If the eluants are allowed to enter reaction device 200, the sample that has passed through measuring instrument 340 may be returned to reaction device 200. Measuring instrument 340 may be a mass spectrometer or a refractometer.

Processing unit 350 includes hardware elements such as a CPU and a memory, or a microcomputer, and controls operation of each of eluant supply unit 310, sample supply unit 320, separation column 330 (column thermostatic bath), and measuring instrument 340. In addition, processing unit 350 processes the result of measurement by measuring instrument 340 to generate a processing result such as a chromatogram indicating a relation between the retention time and the measured intensity of each component. In the case where GPC (gel permeation chromatography) analysis is conducted, processing unit 350 may analyze the generated chromatogram to calculate the average molecular weight of the reaction product.

### Controller

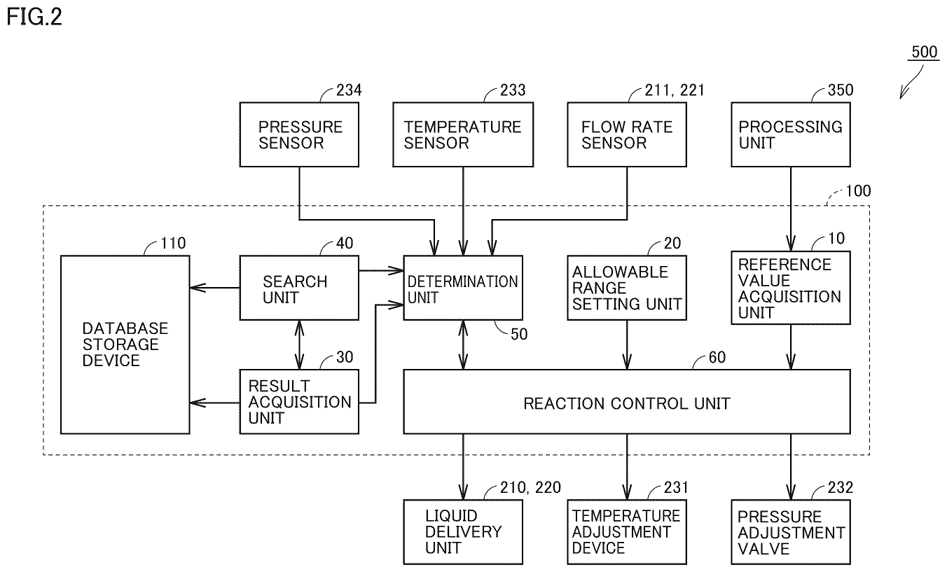

FIG. 2 is a block diagram showing a configuration of controller 100 in FIG. 1. As shown in FIG. 2, controller 100 includes, as its functions, a reference value acquisition unit 10, an allowable range setting unit 20, a result acquisition unit 30, a search unit 40, a determination unit 50, and a reaction control unit 60. Each function may be implemented, for example, through execution, by the CPU of controller 100, of a generation analysis program stored in the memory in a non-volatile manner. Controller 100 also includes a database storage device 110. Some or all of the functions of controller 100 may be implemented by hardware such as electric circuity.

Database storage device 110 includes a large-capacity data server or the like that stores a database. The database may include past results of measurement of the reaction product. The past results of measurement may include a past result of measurement obtained by analyzer 300 in FIG. 1, or may include a past result of measurement obtained by another analyzer and published in a document. The database may also include a design space indicating a relation between an evaluation value indicating the quality of the reaction product, and a combination of the residence time of the first liquid material, the residence time of the second liquid material, the reaction temperature, and the reaction pressure.

Reference value acquisition unit 10 repeatedly acquires a reference value at predetermined time intervals from the chromatogram generated by processing unit 350. For reference value acquisition unit 10, a user can designate a condition for identifying a desired peak in the chromatogram. The reference value may be the magnitude of a specified peak. The magnitude of the peak may be the area of the peak or the height of the peak. The same applies as well to the following description.

The reference value may be a ratio between the magnitude of a specified peak and the magnitude of another peak. The other peak may be a peak adjacent to the specified peak. Alternatively, the other peak may also be specified by the user. The reference value may also be an average molecular weight calculated by processing unit 350. The average molecular weight includes any part or all of the number-average molecular weight, the weight-average molecular weight, and the Z-average molecular weight.

Allowable range setting unit 20 sets an upper limit value and a lower limit value of the reference value acquired by reference value acquisition unit 10. For allowable range setting unit 20, the user can designate the upper limit value and the lower limit value of the reference value to be set for the reaction product to satisfy a predetermined quality.

Result acquisition unit 30 acquires past results of measurement of a designated reaction product, from database storage device 110. For result acquisition unit 30, the user can designate a desired reaction product. In the case where controller 100 is connected to the Internet or the like, result acquisition unit 30 may acquire the past results of measurement of the designated reaction product, from an external server or the like.

Result acquisition unit 30 may present, to the user, a peak to be designated in the chromatogram, based on the condition for analysis, the type of the reaction product, or the like for the acquired past results of measurement. In this case, the user can easily designate, for reference value acquisition unit 10, a desired peak in the chromatogram. Alternatively, result acquisition unit 30 may present, to the user, the upper limit value and the lower limit value to be designated for the reference value, based on the acquired past results of measurement. In this case, the user can easily designate, for allowable range setting unit 20, appropriate upper limit value and lower limit value of the reference value.

Search unit 40 searches database storage device 110 for a design space related to the designated reaction product. The user can designate a desired reaction product for search unit 40. In the case where controller 100 is connected to the Internet or the like, search unit 40 may search an external server or the like for a design space related to the designated reaction product.

Determination unit 50 acquires the amount of the delivered first liquid material, the amount of the delivered second liquid material, the reaction temperature, and the reaction pressure from flow rate sensor 211, flow rate sensor 221, temperature sensor 233, and pressure sensor 234, respectively. In addition, determination unit 50 calculates respective residence times of the first and second liquid materials in reactor 230, based on respective amounts of the delivered first and second liquid materials.

Further, determination unit 50 determines at least one control target to be varied by reaction control unit 60, among the residence time of the first liquid material, the residence time of the second liquid material, the reaction temperature, and the reaction pressure, in reactor 230. Here, the control target may be determined based on at least one of the measurement result acquired by result acquisition unit 30 and the design space found by search unit 40. Alternatively, the control target may be determined based on an algorithm set by the user.

Reaction control unit 60 dynamically varies the control target determined by determination unit 50, in such a manner that the reference value acquired by reference value acquisition unit 10 falls between the upper limit value and the lower limit value that are set by allowable range setting unit 20. Reaction control unit 60 can vary the residence time of the first liquid material, the residence time of the second liquid material, the reaction temperature, and the reaction pressure, by controlling liquid delivery unit 210, liquid delivery unit 220, temperature adjustment device 231, and pressure adjustment valve 232, respectively.

### Extraction of Measurement Value Corresponding to Specific Component

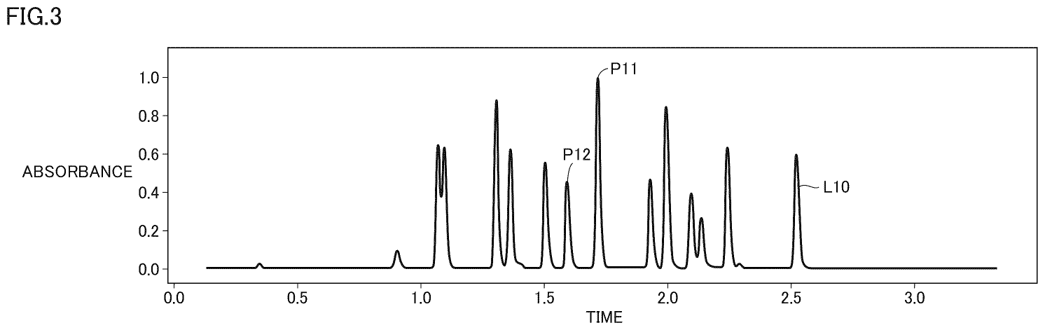

FIG. 3 is diagram showing a chromatogram of a general mixture obtained through chromatography performed at a first flow rate (a flow rate per unit time of a mobile phase). In FIG. 3, the horizontal axis represents retention time (in minutes) in separation column 330. The vertical axis represents absorbance at a given wavelength. That is, in the example of FIG. 3, an absorptiometer is adopted as measuring instrument 340.

In FIG. 3, a line L10 has many peaks including peaks P11 and P12. These peaks are considered as corresponding to respective ones of a plurality of components contained in the mixture. As shown in FIG. 3, when an appropriate flow rate is adopted, the chromatogram can appropriately separate a plurality of components that are contained in the mixture.

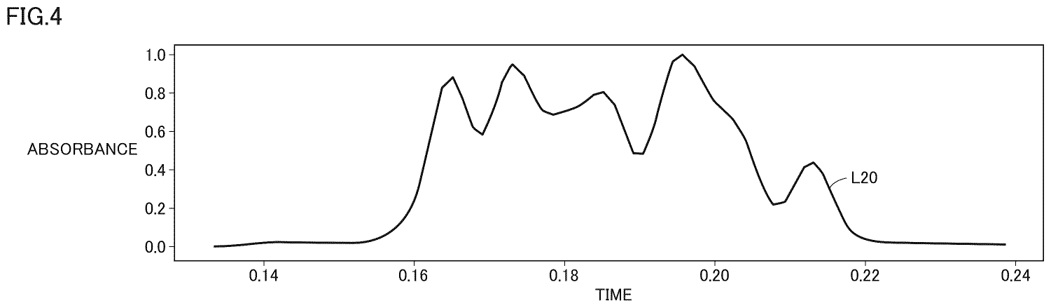

FIG. 4 is a diagram showing a chromatogram of the mixture in FIG. 3 obtained through chromatography performed at a second flow rate. The second flow rate is higher than the first flow rate mentioned in connection with FIG. 3. That is, the example of FIG. 4 corresponds to a chromatogram obtained through chromatography performed at a higher rate than the example of FIG. 3. In the example of FIG. 4, as compared with the example of FIG. 3, a plurality of components contained in the mixture are introduced into measuring instrument 340 without being sufficiently separated from each other in terms of time, and thus a plurality of peaks separated from each other on line L10 in FIG. 3 overlap each other on a line L20 in FIG. 4. More specifically, line L20 appears to collectively represent a plurality of peaks among many peaks included in line L10 in FIG. 3.

A finding is derived from FIGS. 3 and 4 that, in the case where a certain mixture is analyzed, shortening of the process time of chromatography leads to shortening of the measurement time, while the result of measurement provides a plurality of components contained in the mixture that are not sufficiently separated from each other.

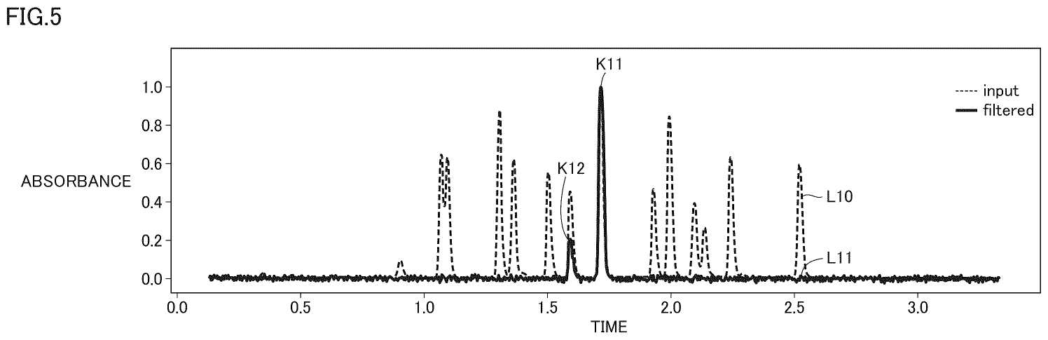

In view of this, according to the present embodiment, in the case where a component of interest in a mixture is specified in advance, processing unit 350 generates a filter for extracting a measurement value of the component of interest, using a chromatogram of the mixture having been subjected to a separation process under a first separation condition. Then, processing unit 350 applies the filter to a result of measurement performed on the mixture that has not been subjected to the separation process under the first separation condition, to thereby extract a measurement value corresponding to the amount of the component of interest, from the result of measurement of the mixture that has not been subjected to the separation process under the first separation condition. Such extraction of a measurement value is described more specifically with reference to FIGS. 5 to 7. The measurement performed on the mixture that has not been subjected to the separation process under the first separation condition refers to analysis of the mixture that has been subjected to a separation process under a second separation condition, an analysis performed under a non-separation condition where components are not to be separated, or analysis performed without the separation process, for example.

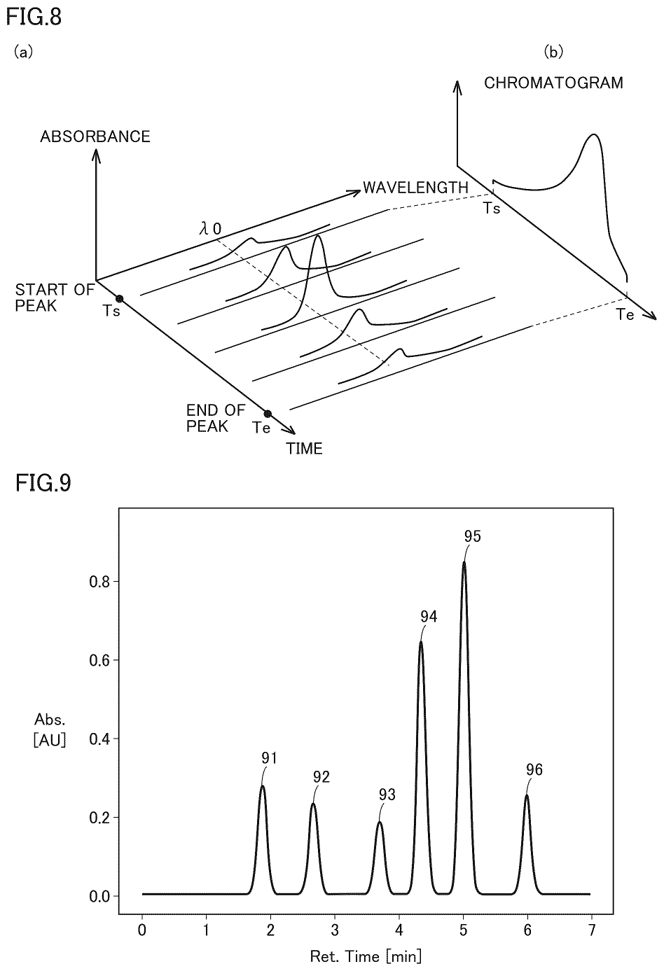

FIG. 5 is a diagram showing the chromatogram in FIG. 3 together with a waveform processed by means of a filter. In FIG. 5, a line L10 represents a chromatogram of a certain mixture at a first flow rate, similarly to line L10 in FIG. 3. A line L11 represents a waveform generated by applying the filter to line L10. The filter is generated in order to extract peak P11 and peak P12 (see FIG. 3). A method for generating the filter is described later herein with reference to FIGS. 8 and 9.

On line L11, peaks K11 and K12 correspond to peaks P11 and P12, respectively. Line L11 does not include conspicuous peaks other than peaks K11 and K12. That is, a filter for extracting peaks P11 and P12 may be applied to line L10, to thereby generate a waveform having peaks K11 and K12 as main peaks that corresponding to peaks P11 and P12, respectively, as indicated by line L11.

To newly generate a waveform by applying a filter to a chromatogram, as described with reference to FIG. 5, may be referred to herein as “to process a measurement result.”

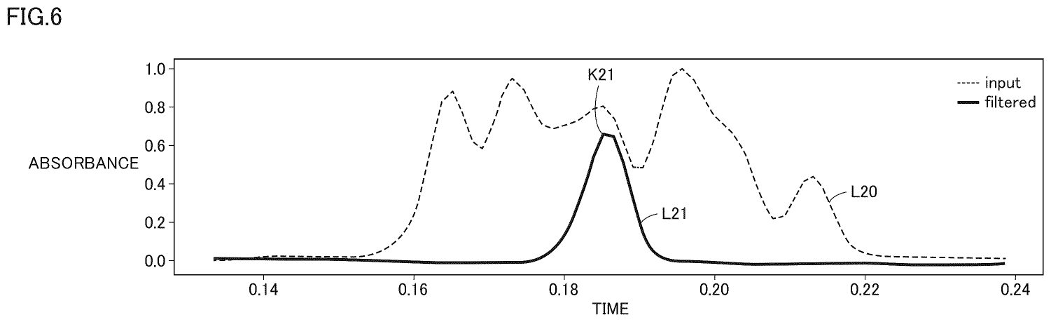

FIG. 6 is a diagram showing the chromatogram in FIG. 4 together with a waveform processed by means of the above-described filter. In FIG. 6, a line L20 represents a measurement result obtained when a certain mixture is introduced into measuring instrument 340 without being passed through separation column 330, similarly to line L20 in FIG. 4. A line L21 represents a waveform generated by applying the filter to line L20. In other words, line L21 is a waveform generated by processing line L20 by means of the filter. While line L20 has a plurality of peaks in the range of the elapsed time from 0.16 to 0.22, line L21 has a peak K21. Peak K21 is considered as a peak extracted as a peak corresponding to peaks K11 and K12 in FIG. 5, by applying the above-described filter.

In FIG. 5, the ratio of the sum of respective peak areas of peaks K11 and K12 to the area of the entire chromatogram indicated by line L11 is “0.0901.” In FIG. 6, the ratio of the peak area of peak K21 to the area of the chromatogram indicated by line L21 is “0.0910.” These ratios are close to each other. This also demonstrates that peak K21 in FIG. 6 is a peak corresponding to peaks K11 and K12 in FIG. 5.

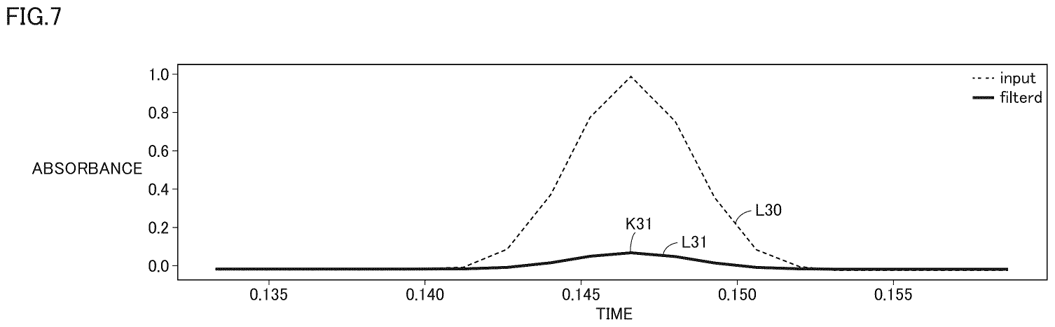

FIG. 7 is a diagram showing a result of measurement obtained when the mixture mentioned in connection with FIGS. 3 to 6 is introduced into measuring instrument 340 without being passed through separation column 330. In FIG. 7, a line L30 represents a chromatogram generated based on the result of measurement from measuring instrument 340. The horizontal axis represents elapsed time (in minutes) from the start of introduction of the mixture into measuring instrument 340, and the vertical axis represents absorbance at a given wavelength, similarly to FIG. 3. In FIG. 7, a line L31 represents a waveform generated by processing line L30 by means of the above-described filter. Line L31 includes a peak K31. Similarly to peak K21 in FIG. 6, peak K31 is also considered as a peak extracted as a peak corresponding to peaks K11 and K12 in FIG. 5.

In FIG. 5, the ratio of the sum of respective peak areas of peaks K11 and K12 to the area of the entire chromatogram indicated by line L11 is “0.0901.” In FIG. 7, the ratio of the peak area of peak K31 to the area of the chromatogram indicated by line L31 is also “0.0901.” These ratios are identical to each other. This also demonstrates that peak K31 in FIG. 7 is a peak corresponding to peaks K11 and K12 in FIG. 5.

As described above with reference to FIGS. 3 to 7, in the present embodiment, a chromatogram (first chromatogram) of a mixture having been subjected to the separation process under the first separation condition is prepared. In the first chromatogram, a peak corresponding to a component of interest is specified. Then, the first chromatogram is used to generate a filter for extracting a measurement value of the component of interest. The filter is applied to a chromatogram (second chromatogram) of the mixture that has not been subjected to the separation process under the first separation condition, to thereby extract the measurement value of the component of interest from the second chromatogram, as indicated by peak K21 in FIG. 6 and peak K31 in FIG. 7.

In the present embodiment, by using the result of measurement by measuring instrument 340 of the mixture having been subjected to the separation process under the first separation condition to generate the filter for extracting the measurement value of the component of interest, a value corresponding to the amount of the component of interest can be extracted from the result of measurement by measuring instrument 340 of the mixture not having been subjected to the separation process under the first separation condition. Thus, it is not necessary to perform the separation process which takes a long time under the first separation condition in order to obtain the value corresponding to the amount of the component of interest in the manufacturing process for the product. In addition, both of the generation of the filter and the acquisition of the value corresponding to the amount of the component of interest are based on the result of measurement by the common measuring instrument (measuring instrument 340). This ensures the validity of the fact that the value acquired without performing the separation process under the first separation condition corresponds to the value acquired by performing the separation process under the first separation condition. Accordingly, monitoring of the process for manufacturing the product can easily be managed, and the validity of the monitoring can easily be examined.

An example of “not having been subjected to the separation process under the first separation condition” may be an example where chromatography is performed at a higher rate than the first separation condition, or an example where chromatography itself is not performed.

According to the present embodiment, it is possible to quantify a component of interest at high speed with high accuracy by performing chromatography at a higher rate than the first separation condition or without performing chromatography.

A possible alternative method for quantifying a component of interest at high speed without performing chromatography may be to provide a measuring device with a high response speed, such as an infrared absorptiometer, a turbidimeter, a thermometer, or a pH meter, to use its output value (for example, a soft sensor as disclosed in “Development of an Adaptive Soft Sensor Method Considering Predictive Confidence of Models” (https://www.jstage.jst.go.jp/article/jccj/11/1/11_24/_pdf)).

However, in the case of the soft sensor, it is generally difficult to find a relation between an output of a measuring device and an estimated value, and further, a phenomenon called “model degradation” where a model becomes inappropriate due to change in environment is known.

In addition, in the case of the soft sensor, a variable to be obtained by a difficult-to-measure method is estimated using a measurement result of an easy-to-measure method and, in order to relate the variable of the former method with the measurement result of the latter method, sophisticated know-how is required. Further, in the case of the soft sensor, sophisticated know-how is also required for determining what method is to be used as “the latter method.” In the case of the soft sensor, however, the relation between the variable of the former method and the measurement result of the latter method is a black box, and sophisticated know-how is also required for examining the validity of the relation.

In contrast, the method according to the present embodiment is less likely to suffer from the disadvantages of the soft sensor, in that the method uses the information (chromatogram) derived from an output of a detector with respect to the direction of time and the information (spectrum) derived from the output of the same detector with respect to the direction of wavelength or mass.

In addition, regarding production of pharmaceutical products, a method has been studied for continuously feeding materials or their mixture into a production line to continuously produce products during a period in which the production process is run, called “Continuous Manufacturing” as described in “Views on Applying Continuous Manufacturing to Pharmaceutical Products for Industry (provisional draft)” (https://www.pmda.go.jp/files/000223711.pdf).

The above-referenced document describes a concern: during Continuous Manufacturing, materials or their mixture is fed continuously into the production line and products are obtained therefrom continuously, and therefore, products failing to meet an intended quality may be manufactured temporarily due possible variations during the process, unless appropriate production management is performed. In order to ensure that products that meet the intended quality are constantly manufactured through the whole process time, it is necessary not only to manage each of unit operations (e.g., blending, granulating, tableting) constituting the production process, like batch manufacturing, but also to know dynamic characteristics in a unit operation (e.g., granulating) and between unit operations (e.g., between blending and granulating). Management of the state during continuous manufacturing is also studied as “State of Control” in “Latest Information on Continuous Manufacturing in Japan” (https://www.pmda.go.jp/files/000239490.pdf).

In addition, “Evolution of Pharmaceutical Manufacturing and Quality Assurance by Quality by Design” (https://www.jstage.jst.go.jp/article/faruawpsj/53/5/53_411/_pdf/-char/ja) discloses, regarding pharmaceutical manufacturing, a “Quality by Design” method as a method for quality assurance of manufactured pharmaceuticals. According to the “Quality by Design” method, each step of manufacturing is managed by monitoring based on chemical analysis, in order to ensure the quality of manufactured pharmaceuticals.

Regarding monitoring as described in the above-referenced document, in order to more precisely analyze a sample to be monitored, it is preferable to separate a plurality of components of the sample using chromatography before the sample is introduced into an analyzer. However, separation by means of chromatography generally takes a long time. In order to monitor a process, however, it is necessary to acquire the result of measurement of the sample in a short time.

In this regard, the method of the present embodiment enables a component of interest to be quantified at high speed with high accuracy by performing chromatography at a higher rate than the first separation condition or without performing chromatography.

### Generation of Filter

In one example implementation, a filter for extracting a measurement value of a component of interest is generated in such a manner that the filter has a function of cancelling measurement values of components other than the component of interest.

In the following, as an example of generation of the filter, a manner is described in which a vector representation of a result of measurement by measuring instrument 340 is used.

In this example, a spectrum is considered as a result of measurement by measuring instrument 340. The spectrum may be in any form, such as an absorption spectrum or a mass spectrum. In the following description, an absorption spectrum is adopted as an example of the spectrum.

Initially, from the spectrum obtained as the result of measurement, a waveform of a portion corresponding to a peak other than the peak corresponding to the component of interest is generated. The generated waveform is formed by a distribution of absorbance in a predetermined wavelength range. Then, the generated waveform is regarded as a set of absorbance data at discrete wavelengths within a predetermined wavelength range, and expressed as a vector VC [a(λ1), a(λ2), a(λ3), . . . , a(λn)] in an n-dimensional space. A(λm) represents the absorbance at a wavelength m (m=1 to n). Then, a vector orthogonal to the aforementioned vector VC in the n-dimensional space is generated as a filter.

In one example implementation, a result of measurement of a reference mixture is used to generate a filter. Then, a spectrum obtained as a result of measurement of a solution to be analyzed is converted into a vector representation, and the inner product of the vector representation obtained by the conversion and the filter is calculated. In the obtained inner product vector, elements corresponding to components other than the component of interest among elements of the vector representation are cancelled. Accordingly, a measurement value corresponding to the component of interest is obtained as the inner product, as indicated by peak K21 in FIG. 6.

### Specific Example of Generation of Filter

Next, a specific example of generation of the filter is described. Initially, a reference mixture is prepared. The reference mixture contains a component of interest. The reference mixture may be extracted, as a product generated at reaction device 200, from reaction device 200 controlled in an ideal state.

Next, the reference mixture is subjected to a separation process using separation column 330 under the first separation condition, and thereafter introduced into measuring instrument 340, and a spectrum is obtained as a result of analysis by means of measuring instrument 340. The first separation condition may include a flow rate for column chromatography.

FIG. 8 is a diagram schematically showing an example of a result of measurement of a general sample. FIG. 8(a) schematically shows three-dimensional chromatogram data obtained as a result of the separation process using separation column 330. The three-dimensional chromatogram data is a collection of absorption spectra at respective measurement times. Absorbance data at a specific wavelength (λ₀, for example) is extracted from the three-dimensional chromatogram data in FIG. 8(a), to generate a chromatogram as shown in FIG. 8(b). The chromatogram in FIG. 8(b) indicates a relation between the measurement time (i.e., retention time) and the absorbance at this wavelength λ₀. The axis representing time and the axis representing absorbance are common to the three-dimensional chromatogram data in FIG. 8(a) and the wavelength chromatogram in FIG. 8(b). By extracting absorbance data at another wavelength (λ₁, for example) from the three-dimensional chromatogram data in FIG. 8(a), a wavelength chromatogram different from the one shown in FIG. 8(b) can be generated.

In the case where three-dimensional chromatogram data for the reference mixture is obtained, a chromatogram generated by extracting absorbance data at a specific wavelength from the three-dimensional chromatogram data forms one example of “reference spectrum” in the present embodiment.

FIG. 9 is a diagram showing an example of the reference spectrum. The chromatogram in FIG. 9 includes six peaks 91 to 96. Selection of a peak corresponding to a component of interest from these peaks is accepted. In response to the selection, a waveform from which the selected peak is removed is generated from the chromatogram in FIG. 9.

An example of the removal of the selected peak is to identify the peak position (peak top position, for example) and the peak width of the selected peak, and remove data in the region of the measurement time corresponding to the identified peak position and peak width. For the identification of the peak width, the tangent method, the half peak height method, the area height method, or the EMG (Exponential Modified Gaussian) method as described in “Formula for Calculating the Number of Theoretical Plates” (https://www.an.shimadzu.co.jp/service-support/technical-support/analysis-basics/hplc/faq/data/lctalk-34tec/index.html) may be adopted, for example.

Then, a vector representation of the waveform “from which the selected peak is removed” is prepared as described above, and a vector orthogonal to the prepared vector representation is specified as a filter.

The filter may be specified by another method. Specifically, the reference spectrum may be modified in such a manner that the peak area of the peak to be removed is zero, and optimization to increase the area of each peak of the modified spectrum (the spectrum including peaks other than the peak to be removed) may be used to specify the filter vector as the “filter” described above. In this way, the filter robust against noise is specified as the “filter.”

A more specific example of specifying the “filter” is described.

It is supposed that a multidimensional vector to be processed that represents, in the form of a vector, a spectrum at a certain measurement time to be processed is denoted by “vector I,” a multidimensional vector that represents, in the form of a vector, a spectrum of a target component (a component corresponding to the “selected peak,” i.e., a component of interest) is denoted by “vector A,” and a multidimensional vector that represents, in the form of a vector, a spectrum of impurities (components other than the component corresponding to the “selected peak”) is denoted by “vector B.” Then, vector I may be expressed by a vector calculation based on Equation (1) below.

I=A+B (1)

Vector B is considered as the one decomposed into a vector Ba dependent on vector A and a vector Bo in a direction orthogonal to vector A. In addition, a multidimensional vector F orthogonal to vector A is considered. Since the inner product of vectors orthogonal to each other is zero, the inner product of vector F and vector Ba is zero. Therefore, the inner product of multidimensional vector I to be processed and vector F is equal to the inner product of vector Bo and vector F. That is, the following Equation (2) holds.

I·F=Bo·F (2)

Since the length of vector Bo is proportional to the length of vector B, Bo·F on the right side of the above Equation (2) is proportional to the length of vector B. Therefore, the vector inner product I·F on the left side of Equation (2) is proportional to the length of vector B representing the spectrum of impurities. Thus, the vector inner product I·F can be used as an index value u representing the amount of the impurities. In view of this, in the present embodiment, processing unit 350 calculates vector F orthogonal to vector A (representing the spectrum of the target component) and specifies this vector as a filter for extracting the impurities.

In this example, vector I represents a spectrum to be processed that is determined from (or derived from) three-dimensional chromatogram data. Processing unit 350 calculates the inner product of vector I and vector F serving as a filter, and determines whether or not the impurities are present, based on the result of the calculation.

According to a typical manner, processing unit 350 calculates, for each spectrum of spectra to be processed that are obtained at respective points in time of measurement with elapse of time, the inner product of vector I representing the spectrum and vector F serving as a filter. Then, processing unit 350 observes change of the value of the inner product along a time series. Processing unit 350 may be configured to determine that an impurity other than the target component is present in a sample corresponding to the spectrum to be processed, when a waveform such as a chromatogram peak appears in the change of the value of the inner product.

When a plurality of types of impurities are present in the sample corresponding to the spectrum to be processed, signals derived from spectra are mixed for a sub-vector (vector F) serving as the filter for extracting impurities at each point in time of measurement. In such a case, a simply calculated average may not appropriately indicate that impurities are contained. Therefore, according to still another embodiment, in generating the filter, an average of a cluster may be determined by clustering a plurality of vectors serving as filters for extracting impurities obtained at respective points in time of measurement, a vector representing the average may be determined, and an inner product for each vector representing the spectrum to be processed at each point in time of measurement and the vector representing the average may be calculated.

For the clustering average, the k-means method, the mean shift method, or the like can be used. Besides, a smoothing filter for which time-series variations are considered, such as a moving average, a bilateral filter, a Kalman filter, or a particle filter may be used.

The number of components (constituents) of interest may be one or more than one. In one example implementation, if the number is one, the number of peaks selected for the chromatogram as shown in FIG. 9 is “1” and, if the number is more than one, more than one peak is selected for the chromatogram as shown in FIG. 9. For example, in the case where the total amount of a plurality of components that are intermediate products is managed in a manufacturing process of a certain product, a solution containing the plurality of components is adopted as a reference mixture, and a plurality of peaks corresponding respectively to these components are selected for the reference spectrum. In this case, a plurality of components of interest constitute an example of “a plurality of types of constituents” in the present disclosure.

### Process Flow

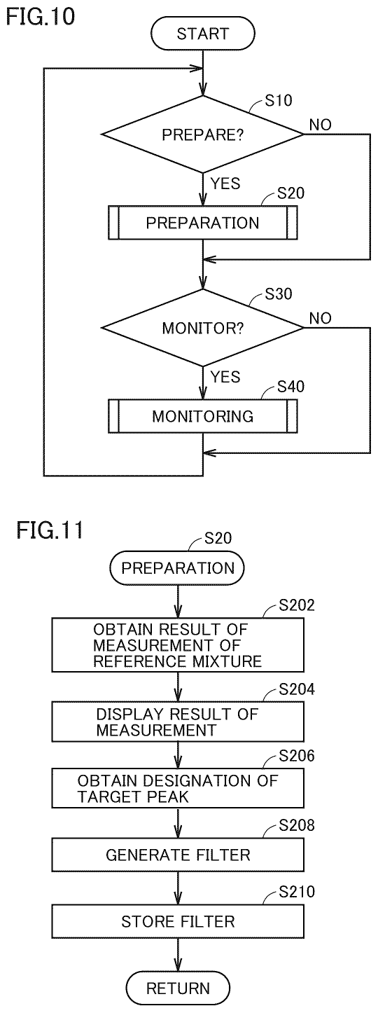

FIG. 10 is a flowchart of a process performed by analyzer 300 to provide information for monitoring a manufacturing process at reaction device 200. In one example implementation, the process in FIG. 10 is implemented through execution of a given program (analysis program, for example) by the CPU of processing unit 350.

Referring to FIG. 10, in step S10, processing unit 350 determines whether or not an instruction to prepare for analysis has been input.

The instruction to prepare for analysis is input to processing unit 350 through operation of input device 352 by a user, for example. More specifically, the user prepares a reference mixture for the manufacturing process at reaction device 200, sets the reference mixture in such a manner that the reference mixture is supplied to separation column 330 through sampling needle 322, and thereafter inputs the instruction to prepare to input device 352. The reference mixture contains a component to be monitored in the manufacturing process.

When processing unit 350 determines that the instruction to prepare has been input (YES in step S10), the processing unit causes the control to proceed to step S20 and, otherwise (NO in step S10), causes the control to proceed to step S30.

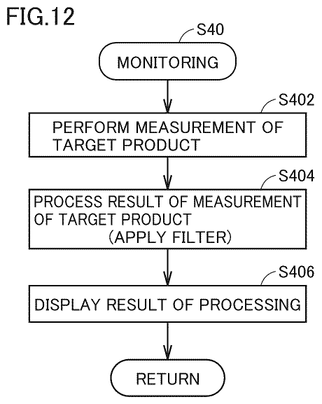

In step S20, processing unit 350 makes preparation. FIG. 11 is a flowchart of a subroutine of step S20. With reference to FIG. 11, details of step S20 are described.

In step S202, processing unit 350 obtains a result of measurement of the reference mixture. One example of the result of measurement is three-dimensional chromatogram data as shown in FIG. 8(a). The result of measurement may be a mass spectrum.

More specifically, the reference mixture is subjected to the separation process (liquid chromatography by means of separation column 330), and thereafter introduced into measuring instrument 340. Based on an output of measuring instrument 340, the result of measurement of the reference mixture is obtained.

In step S204, processing unit 350 causes the result of measurement obtained in step S202 to be displayed on display device 351.

In the case where the result of measurement is three-dimensional chromatogram data, the result of measurement displayed in step S202 may be the three-dimensional chromatogram data itself, or may be an absorption spectrum of a given wavelength (generated from the three-dimensional chromatogram data). In the latter case, the user may use input device 352 to designate a wavelength of the absorption spectrum to be displayed. Processing unit 350 extracts the absorbance of the designated wavelength from the three-dimensional chromatogram data, and causes the absorption spectrum of the designated wavelength to be displayed on display device 351.

In step S206, processing unit 350 obtains designation of a peak corresponding to the component of interest, in the result of measurement displayed in step S204. In one example implementation, the user uses input device 352 to designate the peak in the result of measurement displayed in step S204.

In step S208, processing unit 350 generates a filter. The filter is used for cancelling peaks other than the peak designated in step S206 (or for increasing the peak area of the designated peak), and is generated in the manner described above with reference to FIGS. 3 to 9, for example.

In step S210, processing unit 350 stores the filter generated in step S208 in the memory. Thereafter, processing unit 350 causes the control to return to FIG. 10.

Referring back to FIG. 10, in step S30, processing unit 350 determines whether or not an instruction to monitor the manufacturing process at reaction device 200 has been input. When processing unit 350 determines that the instruction to monitor has been input (YES in step S30), the processing unit causes the control to proceed to step S40 and, otherwise (NO in step S30), causes the control to return to step S10.

FIG. 12 is a flowchart of a subroutine of step S40. With reference to FIG. 12, details of step S40 are described.

In step S402, processing unit 350 measures a product generated by reaction device 200. For this measurement, the product is subjected to the separation process (liquid chromatography by means of separation column 330), and thereafter introduced into measuring instrument 340. The flow rate for the separation process in step S402 may be different from the flow rate for the separation process for generating the filter in step S202. More specifically, the flow rate in step S402 may be higher than the flow rate in step S202 (about 11 times as high as the flow rate in step S202, for example). Accordingly, the process time for the separation process for the monitoring can be made shorter than the process time for the separation process for the generation of the filter. For the measurement in step S402, the product may be introduced into measuring instrument 340 without being subjected to the separation process, i.e., without being passed through separation column 330 (sampling needle 322 introduces the product directly into measuring instrument 340). Then, measuring instrument 340 measures the product and outputs the result of the measurement.

In one example implementation, by the measurement in step S402, an absorption spectrum is generated for a wavelength targeted by the absorption spectrum, based on which the filter is generated in step S208 (the absorption spectrum for which the target peak is designated in step S206). The absorption spectrum generated in this manner is an example of “measured spectrum.”

In step S404, processing unit 350 uses the filter to process the result of measurement of the target product obtained in step S402. More specifically, processing unit 350 generates a vector representation representing the result of measurement of the target product, and calculates the inner product of the vector representation and the filter generated in step S208, to thereby generate an index value. That is, in step S404, processing unit 350 processes the result of measurement of the target product obtained in step S402, to thereby generate the above-described index value.

The value of the peak for the index value corresponds to the amount, in the target product, of the component of interest corresponding to the peak designated in step S206, as indicated by peak K21 in FIG. 6. That is, the value of the peak (the value of absorbance, for example) for the index value is an example of the output value corresponding to the amount of the specific component.

In step S406, processing unit 350 causes the result of the processing in step S404, i.e., the generated index value, to be displayed on display device 351. Thereafter, processing unit 350 causes the control to return to FIG. 10.

In the present embodiment described above, the result of measurement of the product (measurement sample) at reaction device 200 is analyzed. More specifically, as described above with reference to FIG. 11, the reference spectrum derived from the result of measurement, by measurement instrument 340, of the reference mixture corresponding to the measurement sample is used to generate a filter for extracting an output value corresponding to the amount(s) of one or more specific components contained in the reference mixture. The reference spectrum is derived for the reference mixture having been subjected to the process under the first separation condition by means of separation column 330 (separation unit). Then, as described above with reference to FIG. 12, the measured spectrum is derived as a result of measurement, by the measuring instrument, of the measurement sample that has not been subjected to the separation process under the first separation condition. Then, the filter is applied to the measured spectrum, to thereby derive the result of measurement processed as described above. A peak of the processed result of measurement is extracted as an output value corresponding to the amount(s) of the one or more specific components contained in the measurement sample.

In the present embodiment, analyzer 300 displays the result of the processing in step S406 to provide information necessary for monitoring the manufacture of the product at reaction device 200. The manufacture of the product at reaction device 200 is not limited to manufacture by a chemical reaction between a first material (first precursor) and a second material (second precursor). Generation of the product may be achieved by application of a catalyst to one or more precursors of the product. In addition, the one or more precursors may be radical molecules.

In the present embodiment, the monitoring may be performed after a single separation process, or may be performed after a plurality of separation processes. For example, a first filter may be generated based on the result of measurement acquired through a separation process performed on the reference mixture by means of a first mobile phase, and a second filter may be generated based on the result of measurement acquired through a separation process performed on the reference mixture by means of a second mobile phase. The flow rate for the separation processes for generating the first filter and the second filter is set to a first flow rate (first separation condition). For the monitoring, the product is delivered to measuring instrument 340 through the separation process by means of the first mobile phase, and the result of measurement is acquired. The first filter is applied to this result of measurement to thereby generate a first process result, and this result is provided to the user. For the monitoring, the product is further delivered to measuring instrument 340 through the separation process by means of the second mobile phase, and the result of measurement is thus acquired. The second filter is applied to this result of measurement to thereby generate a second process result, and this result is provided to the user. The flow rate for the separation process for the monitoring is set to a second flow rate (second separation condition). The first mobile phase and the second mobile phase are different from each other in terms of pH and/or temperature, for example.

If the concentration of the target component in the target product is high, the result of measurement by the absorptiometer or the mass spectrometer does not have sufficient linearity, so that artifact noise may be generated. In order to avoid generation of the artifact noise, a stray light correction algorithm may be applied to the result of measurement, or limitation on the range of the result of measurement by measuring instrument 340 (for example, the wavelength region of the peak in the case where measuring instrument 340 is an absorptiometer, or the range of m/z in the case where measuring instrument 340 is a mass spectrometer) may be applied, which is used for generating and applying the filter.

In addition, a range of the retention time to be excluded from the target of the analysis at measuring instrument 340 may be defined. For example, the injection shock portion at the time delivery from separation column 330 to measuring instrument 340 is started may be excluded from the target of the analysis.

In addition, a peak that is located further away from a target peak of a chromatogram in the direction of the retention time may also be excluded from the target of the analysis.

In addition, a considerably large peak in the chromatogram (the detected value of the peak top exceeds a given threshold value) may be excluded from the target of the analysis.

In connection with the present embodiment, the example where the sample is in a liquid phase is described above. The present invention is not limited to this, and the sample may be in a gas phase. In this case, gas chromatography is performed instead of liquid chromatography. Alternatively, supercritical chromatography may be performed on the sample in a liquid phase.

In connection with the present embodiment, the example is described above where the second separation condition faster than the first separation condition is implemented by increasing the flow rate of the mobile phase. The present invention is not limited to this, and the second separation condition may be made faster by replacing the column with a shorter column, increasing the column temperature, or changing the solvent of the mobile phase (changing methanol to acetonitrile, for example), instead of or in addition to increasing the flow rate of the mobile phase.

### Modification

In the present embodiment described above, the vector orthogonal to the prepared vector representation is determined, and the vector is used to obtain a measurement value corresponding to the component of interest. The process for obtaining a measurement value corresponding to the component of interest may also be described in the following manner. In the following description, it is supposed that n components (non-specific components) are contained in the sample, in addition to the component of interest (specific component).

Absorbance data at a specific wavelength is extracted from the result of analysis (three-dimensional chromatogram data) to thereby generate a chromatogram. In the chromatogram, n spectra (i.e., n spectra to be removed) are identified respectively for the n peaks other than the peak of the component of interest. The n peaks correspond respectively to the n components. Further, an observation vector V is generated from the chromatogram.

Then, for this observation vector V, initially, calculation of the following Equation (3) using a vector D1 into which a spectrum SP1 is converted is performed, where spectrum SP1 is the first spectrum to be removed, among the n spectra to be removed (spectra SP1 to SPn to be removed, where n is an integer of 1 or more).

R1=V−(V·D1)D1[· is a symbol of inner product] (3)

In the above Equation (3), a vector R1 is obtained that is orthogonal to vector D1, by removing a vector D1 component from vector V to generate vector R1.

Next, for a spectrum SP2 that is the second spectrum to be removed, the following Equation (4) using a vector D2 into which spectrum SP2 is converted is performed, as well as vector R1 obtained for the immediately preceding spectrum to be removed. Before Equation (4) is calculated, vector D2 is processed so as to include only components orthogonal to vector D1. The process for transformation so as to include only the orthogonal components is compression by SVD (singular value decomposition), for example.

R2=R1−(R1·D2)D2 (4)

In the above Equation (4), a vector R2 is obtained that is orthogonal to vector D2, by removing a vector D2 component from vector R1 to generate vector R2.

Here, as described above, vector R1 is a vector derived from vector V and orthogonal to vector D1. In view of this, vector R2 is regarded as a vector derived from vector V and orthogonal to vector D1 and vector D2.

Similarly, for each of the spectrum of n=3and subsequent spectra, a vector Rn is obtained successively using a vector Dn into which a spectrum SPn is converted, as well as a vector Rn-1. Vector Rn is a vector derived from vector V and orthogonal to vectors D1 to Dn.

In this way, according to the present modification, vectors Rn are derived from vector V which is the observation vector as described above, and total intensities (integrated values) of vectors Rn are arranged in the direction of time, to thereby obtain the spectrum of the component of interest. In this modification, vectors D1 to Dn function as filters for extracting the specific component (component of interest).

Here, calculation of the inner product of an appropriate filter vector F and observation vector V is considered. For example, if all elements of vector F are 1, the inner product is the integrated value in the spectral direction.

It is supposed that vector F is accidentally orthogonal to all of the above-described vectors D1 to Dn.

When vector V is decomposed into vector Rn orthogonal to vectors D1 to Dn and dependent components, the inner product of vector V and vector F is determined by the following Equation (5).

V·F=(Rn+αD1+βD2 . . . +ηDn)·F=Rn·F+0+0 . . . +0=Rn·F (5)

That is, the inner product of vector V and vector F is equivalent to the inner product of vector Rn and vector F orthogonal to vectors D1 to Dn.

The SN of Rn·F is maximized when Rn and F are similar to each other, supposing that noise levels at respective wavelengths are equal to each other, since the norm of F is limited to 1 (the same theory as matched filter). Therefore, in terms of SN, the ideal value of F is determined by making the spectrum true values of the remaining peaks orthogonal to D1 to Dn.

### Aspects

It is to be understood by those skilled in the art that the exemplary embodiments described above are specific examples of the following aspects.

(Clause 1) A quantification method according to an aspect is a method for quantifying a specific component contained in a measurement sample, and the quantification method may include: obtaining a measurement spectrum at each of a plurality of points in time by analyzing the measurement sample with chromatography; deriving an index value at each point of the plurality of points in time, by applying a filter for extracting the specific component, to the measurement spectrum at the point of the plurality of points in time; obtaining a chromatogram by arranging one or more index values at respective one or ones of the plurality of points in time; and quantifying the specific component based on a peak of the chromatogram.

With the quantification method according to Clause 1, a technique for quantifying a specific component in a mixture at high speed with high accuracy is provided.

(Clause 2) The quantification method according to Clause 1 may further include obtaining a reference spectrum corresponding to the specific component by analyzing a reference substance with chromatography under a first separation condition.

With the quantification method according to Clause 2, an appropriate spectrum can be obtained as the reference spectrum.

(Clause 3) In the quantification method according to Clause 2, the measurement sample may be analyzed with chromatography under a second separation condition under which analysis is performed faster than the first separation condition, or under a non-separation condition under which each component is not separated.

With the quantification method according to Clause 3, the separation process is performed at high speed or is not performed for the monitoring, which enables the time required for the monitoring to be shortened.

(Clause 4) In the quantification method according to Clause 3, the second separation condition may include, as a flow rate of a mobile phase for separation by the chromatography, a value larger than the first separation condition.

With the quantification method according to Clause 4, the time required for the monitoring can reliably be shortened.

(Clause 5) In the quantification method according to any one of Clauses 2 to 4, the filter may be a vector orthogonal to a vector representation of the reference spectrum.

With the quantification method according to Clause 5, the filter can be generated appropriately.

(Clause 6) The quantification method according to Clause 5 may further include generating the filter by calculating the vector orthogonal to the vector representation of the reference spectrum.

With the quantification method according to Clause 6, it is not required to prepare the filter in advance.

(Clause 7) In the quantification method according to any one of Clauses 1 to 6, the measurement sample may contain a non-specific component different from the specific component, and a vector representation of each of one or more spectra to be removed corresponding to respective one or ones of the non-specific components may be used as the filter.

With the quantification method according to Clause 7, the preparation of the filter is facilitated.

(Clause 8) In the quantification method according to any one of Clauses 1 to 7, the specific component may include a plurality of types of constituents, and the filter may be configured to extract an output value corresponding to respective one of amounts of the plurality of types of constituents contained in the measurement sample.

With the quantification method according to Clause 8, each of a plurality of types of constituents contained in the measurement sample can be quantified.

(Clause 9) In the quantification method according to any one of Clauses 2 to 6, in obtaining the chromatogram, intermittent or continuous sampling may be performed on a flow of the measurement sample, and in quantifying the specific component, for the measurement sample to be sampled in the each sampling, a filter generated from the reference spectrum may be applied.

With the quantification method according to Clause 9, an appropriate filter can be applied to the measurement sample on which the sampling is performed.

(Clause 10) In the quantification method according to any one of Clauses 1 to 9, the measurement sample may be a product obtained through successive chemical change of one or more precursors.

With the quantification method according to Clause 10, a product obtained through continuous chemical change of one or more precursors can be used as a measurement sample.

(Clause 11) In the quantification method according to Clause 10, the chemical change of the one or more precursors may be a chemical reaction between a first precursor and a second precursor.

With the quantification method according to Clause 11, for one or more precursors generated through chemical reaction between the first precursor and the second precursor, a product obtained through continuous chemical change of the one or more precursors can be used as a measurement sample.

(Clause 12) An analysis system according to one aspect may include: a measuring instrument connected to a reaction device that generates a product through chemical change of one or more precursors, the measuring instrument measuring a measurement spectrum of a measurement sample extracted from the product generated at the reaction device; and an analyzer that analyzes an output of the measuring instrument, and the analyzer may perform the quantification method according to any one of Clauses 1 to 11, on the measurement sample extracted from the product.

With the analysis system according to Clause 12, a technique for quantifying a specific component in a mixture at high speed with high accuracy is provided.

(Clause 13) In the analysis system according to Clause 12, the measuring instrument may include at least one of an absorptiometer, a mass spectrometer, or a refractometer.

With the analysis system according to Clause 13, a result derived from at least one of an absorptiometer, a mass spectrometer, or a refractometer is used as a result of measurement.

(Clause 14) A recording medium stores a program in a non-transitory manner, and the program, when being executed by a computer, may cause the computer to perform the quantification method according to any one of Clauses 1 to 11.

With the recording medium according to Clause 14, a technique for quantifying a specific component in a mixture at high speed with high accuracy is provided.

While embodiments of the present invention have been described, it should be construed that the embodiments disclosed herein are given by way of illustration in all respects, not by way of limitation. It is intended that the scope of the present invention is defined by claims, and encompasses all modifications and variations equivalent in meaning and scope to the claims.

What is claimed is:

1. A quantification method for quantifying a specific component contained in a measurement sample, the quantification method comprising:
obtaining a measurement spectrum at each of a plurality of points in time by analyzing the measurement sample with chromatography;
deriving an index value at each point of the plurality of points in time, by applying a filter for extracting the specific component, to the measurement spectrum at the point of the plurality of points in time;
obtaining a chromatogram by arranging one or more index values at respective one or ones of the plurality of points in time; and
quantifying the specific component based on a peak of the chromatogram.

2. The quantification method according to claim 1, further comprising obtaining a reference spectrum corresponding to the specific component by analyzing a reference substance with chromatography under a first separation condition.

3. The quantification method according to claim 2, in obtaining the measurement spectrum, the measurement sample is analyzed with chromatography under a second separation condition under which analysis is performed faster than the first separation condition, or under a non-separation condition under which each component is not separated.

4. The quantification method according to claim 3, wherein the second separation condition includes, as a flow rate of a mobile phase for separation by the chromatography, a value larger than the first separation condition.

5. The quantification method according to claim 2, wherein the filter is a vector orthogonal to a vector representation of the reference spectrum.

6. The quantification method according to claim 5, further comprising generating the filter by calculating the vector orthogonal to the vector representation of the reference spectrum.

7. The quantification method according to claim 2, wherein
in obtaining the chromatogram, intermittent or continuous sampling is performed on a flow of the measurement sample, and
in quantifying the specific component, for the measurement sample to be sampled in the each sampling, a filter generated from the reference spectrum is applied.

8. The quantification method according to claim 1, wherein
the measurement sample contains a non-specific component different from the specific component, and
a vector representation of each of one or more spectra to be removed corresponding to respective one or ones of the non-specific components is used as the filter.

9. The quantification method according to claim 1, wherein
the specific component includes a plurality of types of constituents, and
the filter is configured to extract an output value corresponding to respective one of amounts of the plurality of types of constituents contained in the measurement sample.

10. The quantification method according to claim 1, wherein the measurement sample is a product obtained through successive chemical change of one or more precursors.

11. The quantification method according to claim 10, wherein the chemical change of the one or more precursors is a chemical reaction between a first precursor and a second precursor.

12. An analysis system comprising:
a measuring instrument connected to a reaction device that generates a product through chemical change of one or more precursors, the measuring instrument measuring a measurement spectrum of a measurement sample extracted from the product generated at the reaction device; and
an analyzer that analyzes an output of the measuring instrument, wherein
the analyzer performs the quantification method according to claim 1, on the measurement sample extracted from the product.

13. The analysis system according to claim 12, wherein the measuring instrument includes at least one of an absorptiometer, a mass spectrometer, or a refractometer.

14. A recording medium storing a program in a non-transitory manner, the program, when being executed by a computer, causing the computer to perform the quantification method according to claim 1.
